(19) United States
(12) Patent Application Publication
(10) Pub. No.: US 2024/0311365 A1
(43) Pub. Date: Sep. 19, 2024

(54) SYSTEMS, DEVICES, AND METHODS FOR TRACKING CREATION AND MODIFICATION OF DIGITAL RECORDS

(71) Applicant: IMAGERIGHTS INTERNATIONAL, INC., Boston, MA (US)

(72) Inventors: Hajo Nils Krabbenhöft, Quarnbek (DE); Joe Grant Naylor, West Newton, MA (US)

(21) Appl. No.: 18/400,489

(22) Filed: Dec. 29, 2023

Related U.S. Application Data
(63) Continuation of application No. 18/122,309, filed on Mar. 16, 2023, now abandoned.
Application No. 18/122,309 is a continuation of application No. 17/672,498, filed on Feb. 15, 2022, now abandoned.

(51) Int. Cl. G06F 16/23; H04L 9/32

(52) U.S. Cl. CPC G06F 16/2365; G06F 16/2379; H04L 9/3263

(57) ABSTRACT

Systems and methods for tracking creation and modification of digital records using consensus-driven semi-private blockchain. The present disclosure combines the benefits of Blockchain-like technology with traditional authentication by providing a verifiable immutable link between a low-delay Blockchain-like inscription and a highly trustworthy but delayed confirmation.

### CROSS REFERENCE TO RELATED APPLICATIONS

The present application is a continuation of U.S. patent application Ser. No. 18/122,309, filed Mar. 16, 2023, which is a continuation of U.S. patent application Ser. No. 17/672,498, filed Feb. 15, 2022, now abandoned, which is a continuation of U.S. patent application Ser. No. 16/422,762, filed May 24, 2019, now abandoned, which claims priority to U.S. Provisional Patent Application No. 62/676,229, filed May 24, 2018, the content and disclosures of which are hereby incorporated herein by reference in their entireties.

### FIELD

The subject matter described herein relates generally to systems, devices, and methods for tracking creation and modification of digital records. In particular, the systems, devices, and methods track creation and modification of digital records, such as images, using one or more blockchains.

### BACKGROUND

Blockchain Technology, as it is known and practiced today, can only solve part of the problem of tracking digital records, e.g., images, from creation to use, typically called “Proof of Existence,” in which the immutability of the Blockchain ledger is used to warrant that a certain piece of data existed at a given time and has not been modified since. Another major problem is that the operation of a public Blockchain requires a huge amount of electricity, for example, with the BitCoin network exceeding the combined consumption of all of Denmark, thus making a full-scale Blockchain prohibitively expensive to operate. Even the mere participation in a public Blockchain necessitates high costs either for mining hardware and electricity or for transaction fees. And since Blockchains only provide a partial solution to the problem, their validity as proof in court is still undecided. On the other hand, filing the data to be warranted with a traditional notary or government office incurs high processing delays and costs.

Thus, needs exist for systems, devices and methods for tracking creation and modification of digital records using blockchains and blockchain-like technology without the above mentioned and other disadvantages.

### SUMMARY

Provided herein are example embodiments of systems, devices and methods for tracking creation and modification of digital records using consensus-driven semi-private blockchain.

In some embodiments, the present disclosure generally provides efficient, affordable and practical applications and solutions that allow participating users and data processing companies to operate a consensus-driven semi-private blockchain whose contents are warranted by public blockchains, government offices or other authorities, while still allowing for high timestamping precision, short processing delays and offline registration of new data. As a result, choosing a trade-off between processing delay and trustworthiness can be avoided by connecting both the low-delay and the high-trustworthiness data through a hierarchy of immutable Blockchain and novel Blockchain-like ledgers.

The present disclosure provides further improvements such as optimization of computer resources, improved data accuracy and improved data integrity, to name only a few. In a number of embodiments, instructions stored in the memory of computing devices (e.g., software) can cause one or more processors to perform the steps of the embodiments described herein. Additionally, many of the embodiments disclosed herein reflect an inventive concept in the particular arrangement and combination of the devices, components and method steps utilized for tracking creation and modification of digital records using consensus-driven semi-private blockchain.

In some embodiments, the present disclosure may include a system for tracking creation and modification of digital records using consensus-driven semi-private blockchain, comprising: a first plurality of nodes comprising a public blockchain, a second plurality of intermediate nodes comprising a semi-private blockchain and communicating with the first plurality of nodes, wherein one or more nodes of the intermediate nodes host a server software, a plurality of user devices, wherein each user device comprises a blockchain client and communicates with one or more nodes of the intermediate nodes to ingest first data into the one or more nodes of the intermediate of nodes, and one or more third-party authorities communicating with the one or more nodes of the intermediate nodes.

In some embodiments, the blockchain client, which may be offline, inscribes the first data before ingesting the first inscribed data into the one or more nodes of the intermediate nodes. The intermediate nodes may inscribe the first inscribed data ingested from the plurality of user devices, forming second inscribed data, and ingest the second inscribed data into the one or more first plurality of nodes. In some embodiments, the intermediate nodes register the second inscribed data with one or more third-party authorities after a predetermined time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated in and constitute a part of the specification, are for illustrative purposes only of selected embodiments, serve to explain the principles of the invention. These drawings do not describe all possible implementations and are not intended to limit the scope of the present disclosure.

FIG. 1 shows an exemplary processing delay and trustworthiness chart.

FIG. 2 shows an exemplary operation (or application) of the system of the present disclosure, according to various embodiments.

FIG. 3 shows an exemplary high-level diagram the system of the present disclosure, according to various embodiments.

FIG. 4 is an exemplary diagram showing how a public Blockchain may be operating, according to various embodiments.

FIG. 5 is an exemplary diagram showing how a semi-private Blockchain may work and may be used with the present system, according to various embodiments.

FIG. 6 shows an exemplary hierarchical embedding of parent hashes into Blockchain-like and novel data structures, according to various embodiments.

FIG. 7 illustrates exemplary hardware platforms for the IRPBC and IRBC, according to various embodiments.

FIG. 8 illustrates exemplary components for the IRPBC, according to various embodiments.

FIG. 9 illustrates exemplary IRPBC structure and data, according to various embodiments.

FIGS. 10 to 14 illustrate exemplary flow diagrams of exemplary tasks of the IRPBC component, according to various embodiments.

FIG. 15 illustrates exemplary components for an IRBC, according to various embodiments.

FIG. 16A illustrates an example of status information, showing an image of a BitCoin Blockchain inscription verification website, according to various embodiments.

FIG. 16B illustrates an exemplary user interface showing verification status of a file, according to various embodiments.

FIG. 16C illustrates an exemplary user interface showing a smart contract event log, according to various embodiments.

FIG. 17 illustrates another exemplary IRPBC structure and data, according to various embodiments.

FIGS. 18 to 23 illustrate exemplary flow diagrams of exemplary tasks of the IRBC component, according to various embodiments.

FIG. 24 shows an exemplary flow diagram of the steps for the creating and submitting copyright work records, according to various embodiments.

### DETAILED DESCRIPTION

The present disclosure relates to systems, devices and methods for tracking creation and modification of digital records using consensus-driven semi-private blockchain.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

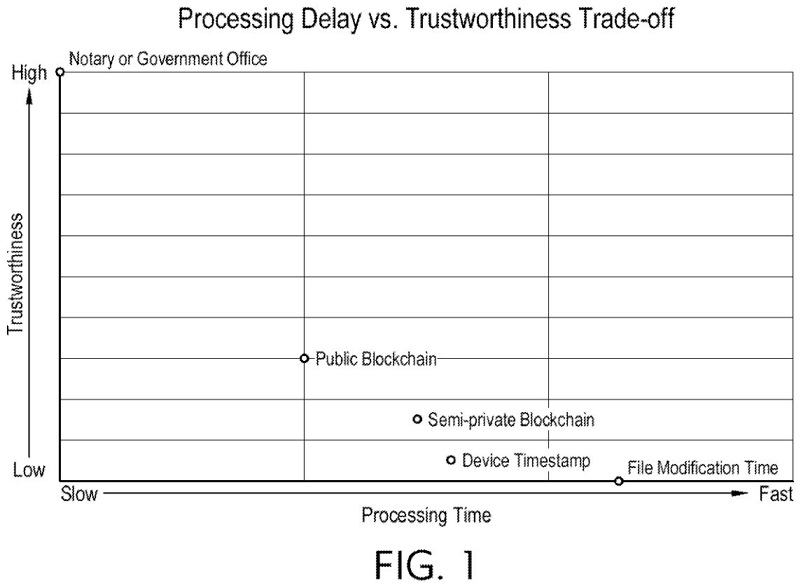

FIG. 1 shows an exemplary processing delay and trustworthiness chart. Traditional authentication services or authorities, e.g., notary or government services, are very trustworthy but have slow processing time. Public Blockchain technology has shorter processing time but is less trustworthy.

In some embodiments, the present disclosure combines the benefits of Blockchain-like technology with traditional authentication, e.g., notary or government services, by providing a verifiable immutable link between a low-delay Blockchain-like inscription and a highly trustworthy but delayed confirmation, e.g., by a notary or government service. As such, data can be inscribed swiftly at a low trustworthiness level, which can then subsequently be increased by each additional confirmation step, until it is raised to the highest possible level after the data has been confirmed, e.g., by a notary or government service.

Although embodiments described herein may show exemplary tracking creation of photographic images from RAW file throughout the retouching and modification processes until sale and/or publication, with optional registration of the newly created artworks with the U. S. Copyright Office, person of skill in the art will understand that the described technology can apply equally for any type of data files and/or timestamped event log. For example, the exact same technology can be used for tracking car movements based on GPS and then linking this car movement history with the private use declaration on a German tax registration form. Or it can be used for tracking the exact timings and dosages of drug injections in order to improve patient safety and doctor-nurse-cooperation in a hospital, and then automatically verifying the records of what has been injected against the prescription inside the patient's digitalized medical records.

In some embodiments, to make a practical implementation of such a system of the present disclosure affordable, an intermediate semi-private Blockchain may be introduced between a point of origin device or application and a public Blockchain. Thereby, new data can be confirmed at an intermediate trustworthiness level with relatively low latency and low costs, until the data can be confirmed by a public Blockchain. This intermediate buffer can be used for combining a multitude of new data items into one paid-for public Blockchain inscription, thereby greatly reducing the associated transaction costs.

In some embodiments, to make a practical implementation of a system of the present disclosure usable for users with limited internet connectivity and/or limited processing power—for example, a traveling photographer or a driving salesman—the present disclosure includes a novel system that can produce Blockchain-like event, transaction and file inscription services both offline and on extremely limited hardware, such as inside an SD (Secure Digital) card or an Internet of Things (IoT) device.

Taken alone, an offline inscription of a new item file would be considered very untrustworthy and, thus, likely of little value, e.g., as used in court. But due to the linking property of the overall system described in this disclosure, the trustworthiness level of the inscription is subsequently increased by linking it with subsequently more delayed but also more trustworthy ways of confirmation.

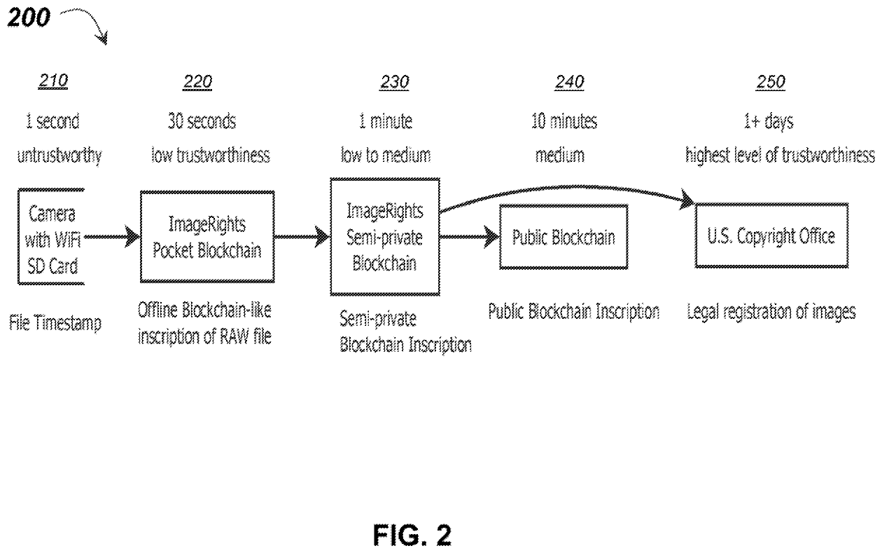

Shown in FIG. 2 is an exemplary operation (or application) 200 using the system and method of the present disclosure, according to some embodiments. In some exemplary operations, at 220, a traveling photographer may use the system to inscribe a new RAW file at a first predetermined time precision, e.g., 30-seconds, with a very low level of trustworthiness offline, which may then be increased to a slightly higher level of trustworthiness as soon as he regains internet connectivity at 230, when the inscription may then be increased to the low to medium trustworthiness of a semi-private Blockchain within a second predetermined time, e.g., a minute, which may then be increased to the medium to high trustworthiness of a public Blockchain within a third predetermined time, e.g., 10 minutes. At 250, the inscription may then be increased to the highest possible level of trustworthiness through an authentication service or authority, e.g., notary or government registration, within a fourth predetermined time, e.g., 24 hours. The government registration, for example, will then warrant the photographer's rights to the new image with a precision of one day for the timestamp. In the example of FIG. 2, the offline blockchain device may mine a new block every 30 seconds. As a result, the offline blockchain can prove the time up to a 30 second window. If a higher precision is needed, the linking property of the system described herein may then be used to validate the prior inscription levels against the government registration and—if successful—to increase the precision of the timestamp back up to the level of the first offline inscription, e.g., 1 second.

In some embodiments, due to the extremely low level of processing resources needed for the first offline inscription level, the system may be embedded into SD cards, IoT devices, scanners, digitizers, digital cameras, and the likes. That way, it can be technically warranted that the user will not forget to register any important data or that the data has been altered, either erroneously by the user or maliciously by another actor. In the example of photographers, forgetting to register a new work with the U. S. Copyright Office can lead to very high losses in the form of unrecoverable lost licensing revenue later. A technical system incorporating the technology of the present disclosure can prevent such a costly mistake while simultaneously collecting all the data needed for automatic license verification and policing.

In some embodiments, to accommodate the typical real-world case that images or data files, are not only created, but also modified, sold and licensed, the system may allow implementors to easily define their own types of transactions to be inscribed and warranted by the system. Some exemplary implementations include the case of a photographer retouching a RAW file from the camera to produce the final JPEG image which is subsequently distributed and published.

A person of skill in the art will understand that the same basic process can also be used for changes to any kind of digital records, for example when ownership of a data item is transferred to another party by modifying the ownership record.

Exemplary Problems with Blockchains and Solutions Provided by the Present Disclosure

In some embodiments, the system described herein can solve at least the following three main pain points commonly associated with the use of Blockchain technology:
(1) A private blockchain or a small community with few financial incentives for consensus will likely encounter split-brain as soon as the involved parties disagree about the history. The system can solve this by inscribing the consensus blocks from the private blockchain into a smart contract hosted on a public blockchain, thereby limiting the time span during which disagreement can occur. In some implementations, this inscription may be performed once every pre-determined time period, e.g., every 24 hours, which means that at any time for participants of the semi-private Blockchain there can only be disagreement for things that have happened within the last 24 hours. In copyrights applications, since copyright challenges tend to occur on a much longer time scale, e.g. the image's use is disputed weeks later, this avoids any practical negative effects caused by disagreement about the Blockchain's history.
(2) Piggybacking on a public blockchain, such as BitCoin or Ethereum, will incur transaction fees for every token sale, event inscription or state change. As such, these are not financially viable for events that happen often (e.g., new photo taken) or states that change frequently (e.g., image metadata modification). The system may solve this by using a new Blockchain-like data structure to avoid processing fees while still retaining the immutability guarantees needed for practical use. This may be referred to as Extended Semi-private Blockchain.
(3) Not every user (e.g., photographer) will have Internet connectivity at all time, which would be required to use blockchain technology as it is currently practiced. The system may solve this by enabling offline inscription of events through the use of a new data structure. This can be referred to as Pocket Blockchain technology, or Embedded Blockchain technology, depending on the particular implementation.

### Exemplary High-Level Design of the System of the Present Disclosure

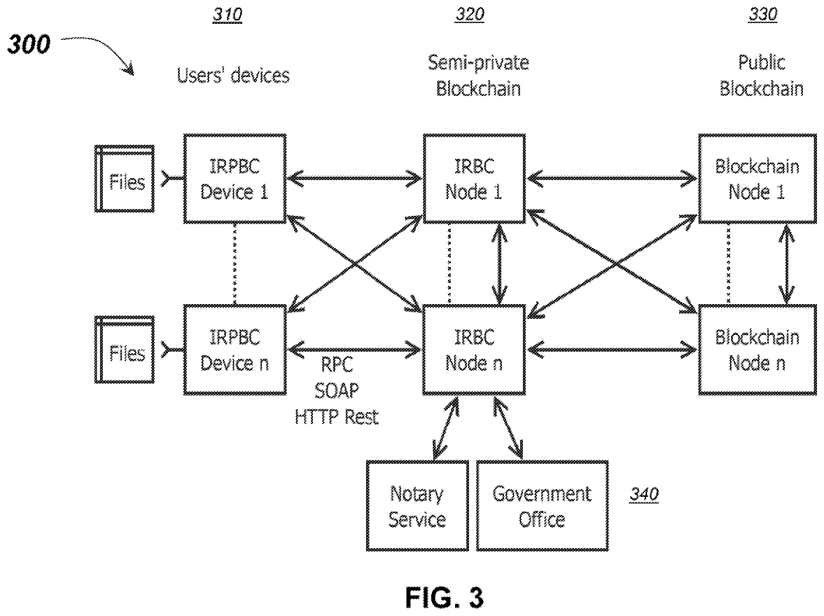

FIG. 3 shows an exemplary high-level diagram 300 of the system of the present disclosure, according to some embodiments. In some embodiments, the system may include at least three types of software or hardware devices, namely the nodes 330 running the public Blockchain, the nodes 320 running the semi-private Blockchain (referred to herein as “ImageRights semi-private Blockchain”, or IRBC), and the devices 310 running the Pocket Blockchain Client (referred to as “ImageRights Pocket Blockchain Client”, or IRPBC) component for ingesting new data and new files into the system.

In some embodiments, each user of the system may control one or more devices 310 running the IRPBC hardware implementation and/or IRPBC client software. Each of the users' devices 310 may contain one or more data files to be inserted into the system, for example RAW image files. There may be one or more IRBC nodes 320 hosting a server software and the IRBC nodes communicate with each other. There may be one or more nodes 330 participating in the public Blockchain by executing the appropriate public Blockchain software and communicating with each other. There are outside authorities, such as notary services or government offices.

In some exemplary operations, the users' IRPBC devices 310 may each connect to one or more randomly chosen IRBC nodes 320, for example through remote procedure calls, such as SOAP or HTTP REST. These connections may be used for inscribing data from the potentially offline-created Pocket Blockchain into the semi-private Blockchain. The IRBC nodes 320 may each connect to one or more randomly chosen public Blockchain nodes 330 using the respective protocol of that Blockchain. These connections may be used for warranting the data stored in the semi-private Blockchain by inscribing it into the public Blockchain. In some embodiments, the IRBC nodes 320 may each also connect to external authorities 340, such as notary services or government offices, for producing provenance of the highest possible trust level, for example by registering image files with the U.S. Copyright Office.

### Public Blockchain Function

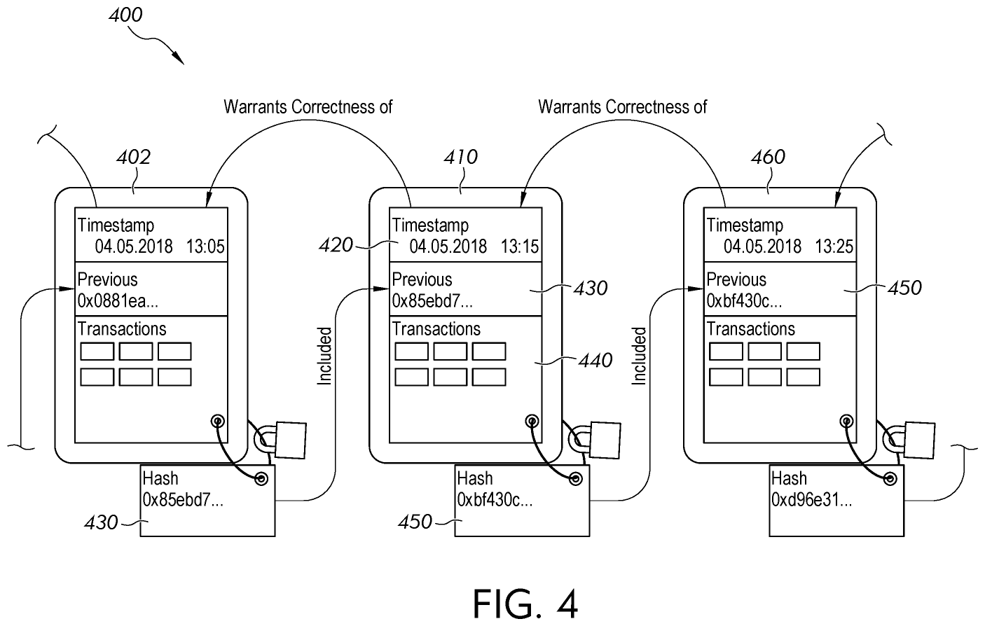

FIG. 4 is an exemplary diagram 400 showing how a public Blockchain—as it is currently known in the arts—may be operating, according to some embodiments. The nodes participating in the public Blockchain may run various stock Blockchain open-source software packages and cooperate with each other through the use of a shared Blockchain protocol. Of specific interest is how a public Blockchain gains its immutability on which the “Proof of Existence” functionality is based. Every block 410 that is created may contain at least a timestamp 420, the hash 430 of the previous block 402, and one or more transactions 440. Once the data contained inside the block 410 is finished, the hash 450 of it is calculated, and that hash is then included in the next block 460. The hashes may be calculated using a one-way cryptographic function, so that it is impossible to change the block data without simultaneously changing the block hash. Therefore, the hash included in the next block warrants the correctness and immutability of the preceding block.

### Extended Semi-Private Blockchain

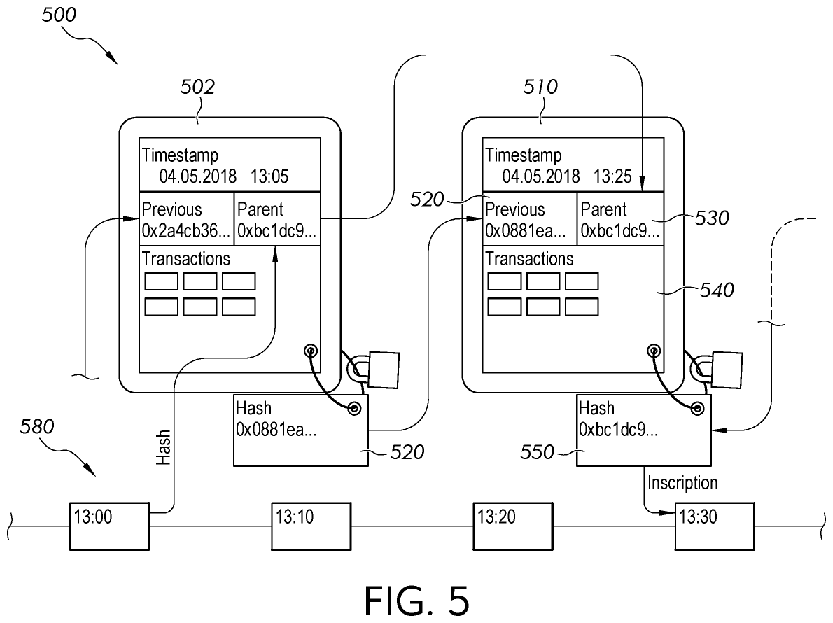

FIG. 5 is an exemplary diagram showing how a semi-private Blockchain 500 may work and may be used with the present system, according to some embodiments. The semi-private Blockchain that is operated and shared by IRBC nodes may be a new data structure 510 which contains a field for a parent hash 530 in addition to the regular Blockchain data 540. When a new block 502 for the semi-private Blockchain is created, the hash 530 of the most recent consensus block from the public Blockchain is inscribed into it.

In the other direction, the hash 550 of the most recent consensus block from the semi-private Blockchain may be inscribed into the public Blockchain regularly, for example once per day. For case of automation, a smart contract executing in the public Blockchain may be used for this, but it would also be possible to emulate the smart contract's behavior using a regular data transaction inscribed into the public Blockchain.

A purpose of inscribing hashes from the public Blockchain into the semi-private Blockchain and vice versa is to provide bounds for the timing of blocks and immutability guarantees. If the public Blockchain is immutable, then any part of the semi-private Blockchain whose hash has been inscribed into the public Blockchain is also immutable. And because it is impossible to know the hash of a block before it is created, the fact that the semi-private blocks contain the hash of a public block proves that the semi-private block was created after the public block.

In the illustration of FIG. 5, the inclusion of the hash 530 of the public Blockchain 580 block from 13:00 into the semi-private block 502 with hash “0x0881ea . . . ” proves that the semi-private block 502 has to be created after 13:00. And the inscription of the hash “0xbe1dc9 . . . ” from the second semi-private block 510 into the 13:30 block of the public Blockchain 580 makes both semi-private blocks (502 and 510) immutable and proves that both blocks (502 and 510) have been created before 13:30.

In other words, the parent field that is unique to the system's Blockchain data structure allows the hierarchical embedding of shorter lower-trustworthiness Blockchains (e.g., 500) into longer higher-trustworthiness Blockchains (e.g., 580) and to derive timing and immutability guarantees from such an embedding. The same principle of deriving timing guarantees and provenance from a hierarchy of Blockchains and Blockchain-like systems is also used between the IRPBC component and the IRBC nodes.

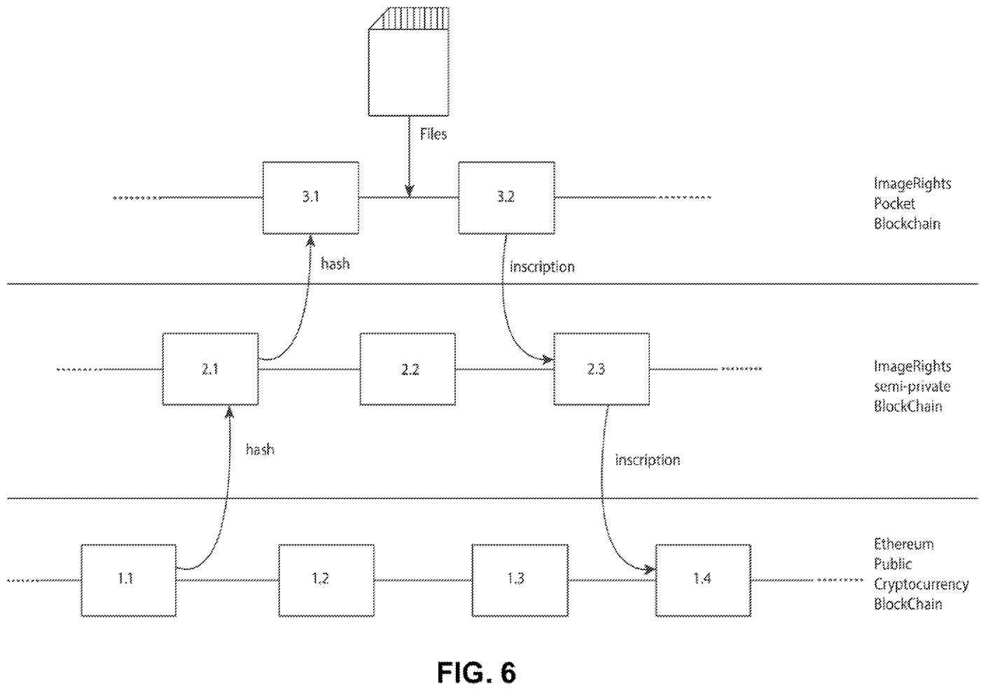

Turning to the exemplary illustration in FIG. 6, according to some embodiments, the semi-private block 2.1 includes the hash from the public block 1.1, and the potentially offline-generated IRPBC block 3.1 includes the hash of the semi-private IRBC block 2.1. The hash of the potentially offline-generated IRPBC block 3.2 is included in the semi-private IRBC block 2.3, and the hash of block 2.3 is in turn included in the public block 1.4. As a result, the offline-generated IRPBC blocks 3.1 and 3.2 are provably immutable after the public block 1.4 has been created and it is warranted by the public Blockchain that the following order applies: 1.1 before 3.1 before 3.2 before 1.4.

As a result of the hierarchical embedding of parent hashes into Blockchain-like and novel data structures, a time range for the possible creation times of offline-generated blocks can be provided. Another benefit provided by this architecture is that the new files can be inscribed into the Pocket Blockchain into block 3.2 with a low delay and low cost, but also with a low level of trustworthiness and that the provenance for these files can be increased afterwards when block 2.3 is created and again when block 1.4 is created.

### IRPBC and IRBC Hardware Platforms

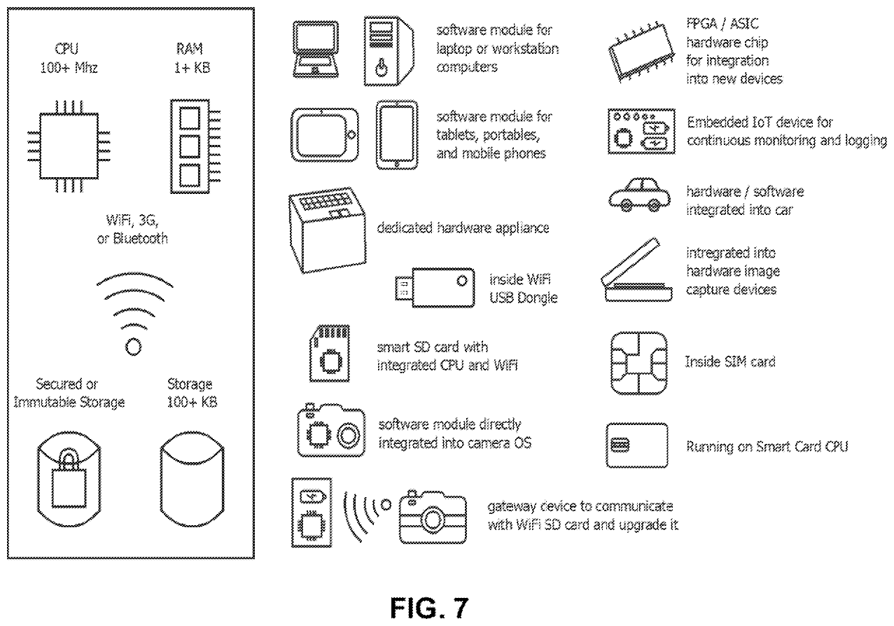

FIG. 7 illustrates exemplary hardware platforms for the IRPBC and IRBC, according to some embodiments. A person of skill in the art will understand that the examples are not limiting and can include other suitable platforms.

In some embodiments, the system can be integrated in hardware into a data source. For example, a special digital camera with the IRPBC system integrated as a hardware ASIC or a regular digital camera containing a Wi-Fi SD card which includes the IRPBC system can both directly inscribe new files into the system, thereby removing any risk that the user might forget to do so or that the files have been altered. Similarly, a smart car that can track itself through an integrated IoT device to make sure that the user will never alter or forget to record a tax-relevant trip. And a smart needle that automatically warns the nurse if a colleague had already performed the prescribed drug injections, or if one is significantly overdue, could reduce dangerous mistakes caused by inattentiveness. In some embodiments, the IRPBC system may be portable, small, and embedded into other tools such as cameras, cars, or hospital equipment.

The IRBC nodes on the other hand, may be hosted either by a service provider, such as ImageRights International, Inc., or by the users themselves. In some applications, there may be no practical benefit gained from integrating the IRBC nodes into the aforementioned embedded devices. Also, the IRBC nodes need to communicate with each other and with a public Blockchain, so they cannot operate correctly without Internet connectivity. As such, in some applications, it constitutes no disadvantage if the IRBC nodes require deployment on specialized hardware and/or workstation- and server-class computer hardware.

Accordingly, in some embodiments, the beginning of the processing pipeline, namely the IRPBC functionality, may be implemented as a software library suitable for integration into other applications, as a standalone software application, for example for execution on mobile phones, tablets, laptops or workstation computers, and also as a dedicated hardware solution, both using embedded processors, such as those found in Wi-Fi SD cards or car electronics, and also as a pure FPGA- or ASIC-based hardware design, which would be suitable, e.g., for direct integration into digital cameras or hospital equipment.

In some embodiments, to make implementations on those very diverse hardware and software platforms possible, the IRPBC component can work within the constraints imposed by the lowest common denominator found in all of these devices, which can be, e.g., roughly 100 MHz of CPU processing power or its equivalent as a 100 MHz FPGA or ASIC, 1 KB of memory and 100 KB of storage space. The average mobile phone sold nowadays has 1000 times the memory capacity as the constraints required herein, so it is immediately obvious that implementations on small embedded devices are made possible by moving CPU- and memory-intensive operations from the IRPBC component over to the IRBC nodes, as the latter operate on regular server hardware.

Because IRPBC and IRBC are independent but complementary systems, embedded IRPBC hardware requires the occasional availability of an Internet connection to one or more IRBC nodes, may which lead to a federated network. When deployed to more powerful devices, such as workstation computers, both IRPBC and IRBC can be executed alongside on the same hardware, thereby making the system fully distributed.

### IRPBC: Pocket Blockchain

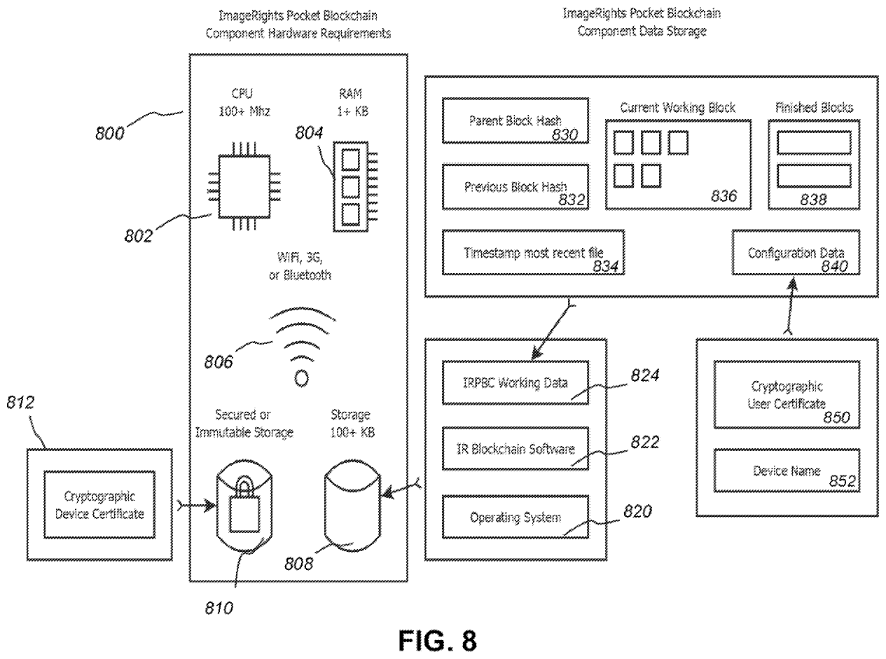

FIG. 8 illustrates exemplary components for the IRPBC, according to some embodiments. In some embodiments, a purpose of the IRPBC is to ingest new data, such as logs, transactions, events or files into the system and to provide a basic level of provenance for the timing and history of that data. For example, the IRPBC would be part of the GPS logging module of a smart car, the injection verification system of the hospital, or it would be part of the RAW image processing of a digital camera that inscribes the generated images for copyright purposes.

In some embodiments, the IRPBC may not implement or maintain a Blockchain data structure, as it is currently known in the field and used for public Blockchains such as Ethereum and BitCoin. Instead, it may maintain a novel data structure that has been explicitly designed to provide a Blockchain-like immutable ledger with integrated provenance and proof of existence capabilities on embedded devices with limited resources and unreliable internet connectivity. In a practical sense, the IRPBC provides an embedded offline-capable Blockchain, but it does so using a new data structure and the RPC API provided by the IRBC nodes.

An IRPBC device 800 may include at least a CPU 802 or equivalent FPGA or ASIC, RAM 804, some of network connectivity 806, and storage 808. The IRPBC device may also integrate secured or immutable storage 810 which can be used to permanently store a cryptographic device certificate 812 that uniquely identifies the device. For example, this might be a camera's serial number, a mobile phone's IMEI, a file stored on a smart card, or just an EPROM chip that is initialized during manufacturing.

As for the regular device storage, an IRPBC device may include at least an operating system 820 for basic input/output functions, and for controlling the network connectivity, a copy of the Pocket Blockchain software 822, and storage reserved for the IRPBC working data 824.

In some embodiments, the IRPBC working data may include at least the hash 830 of the current parent block in the IRBC Blockchain, the hash 832 of the previous block issued by this IRPBC device, the timestamp 834 of the most recently processed file, the incomplete current working block 836, zero, one or more finished blocks 838 and a configuration area 840. The configuration area may include a certificate 850 that uniquely identifies the user as well as a device name 852 chosen by the user. The user certificate may be needed so that every user can prove his/her rights with regards to every file inscribed by the IRPBC without disclosing his/her identity towards IRBC servers, service providers or the public Blockchain. The device name may be used purely for convenience, so that users that own multiple IRPBC-integrated devices, for example a camera with smart SD card and a mobile phone, can easily distinguish between the data produced on each device.

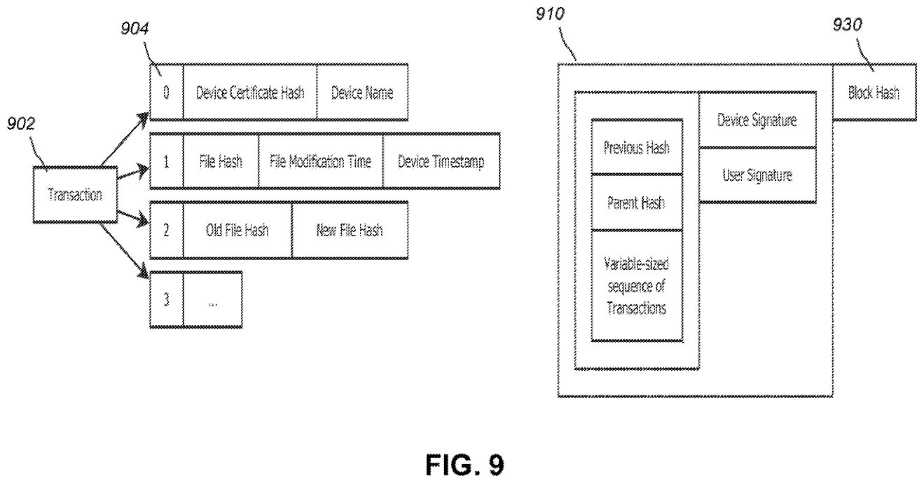

The two core data structures used by the IRPBC are transactions and blocks. FIG. 9 illustrates their exemplary structure and data, according to some embodiments.

In some embodiments, a transaction 902 may include a number 904 to identify its type, followed by a variable number of type-specific fields. A block 910 may include the hash of the preceding IRPBC block as well as the hash of the most recent known preceding IRBC consent block from the semi-private Blockchain (“Parent Hash”). A block may also include a variable-sized sequential list of the data streams for the contained transactions. Once this core data for a block is finished, it may then be cryptographically signed both with the certificate identifying the IRPBC device (see 812 in FIG. 8) and with the certificate identifying the device's user (see 850 in FIG. 8) thereby producing two digital signatures. In other words, the Cryptographic Device Certificate (see 812 in FIG. 8) and the Cryptographic User Certificate (see 850 in FIG. 8) may be used to generate a digital signature, which may be a short number sequence that proves that the user had access to both the data and the certificate. The combined data 910—that is hashes, transactions and signatures—is then hashed to produce the hash 930 for the complete block. That hash is appended to the block data, as it can be used to verify the integrity of the data.

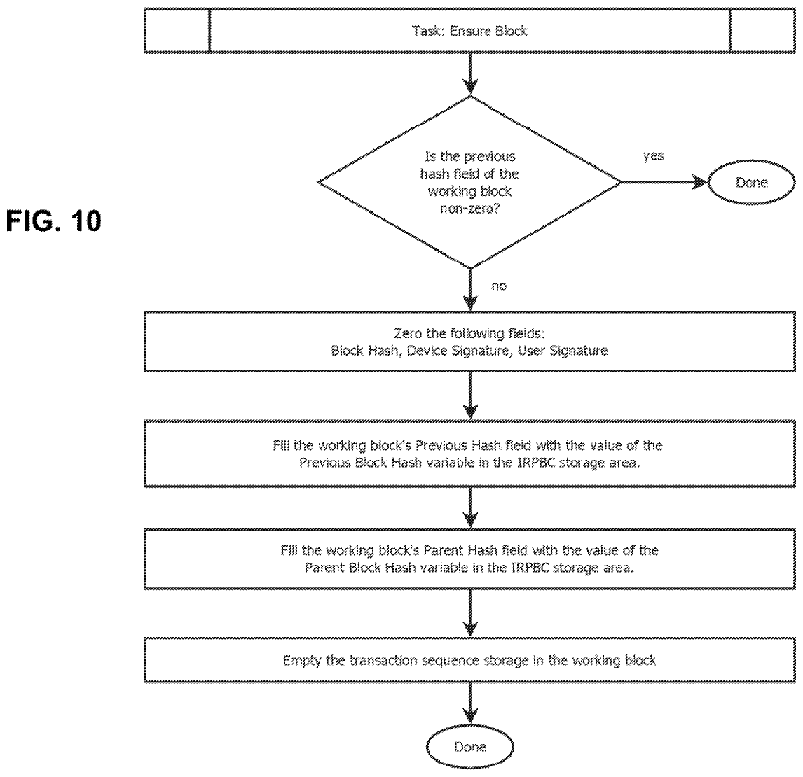

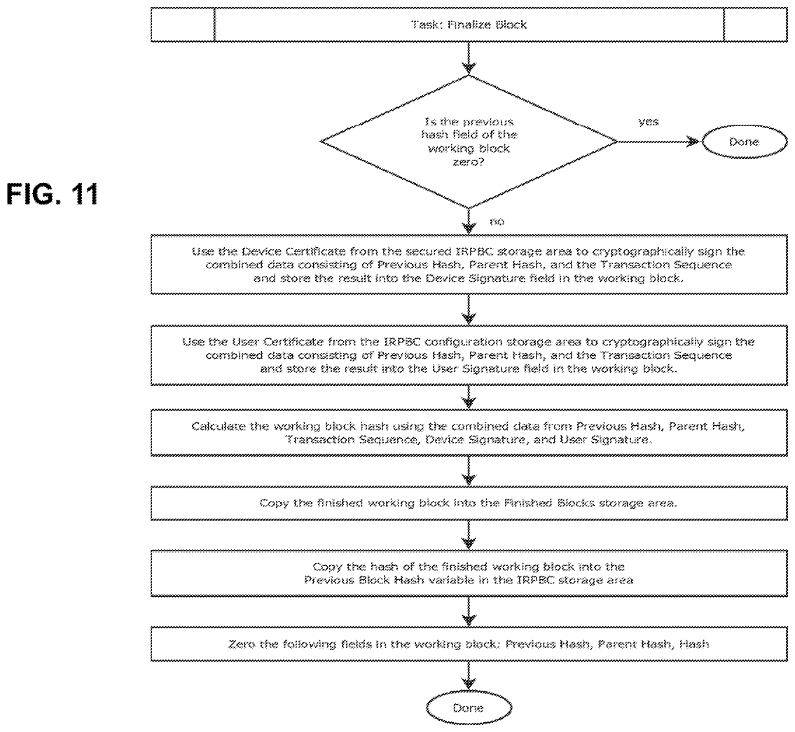

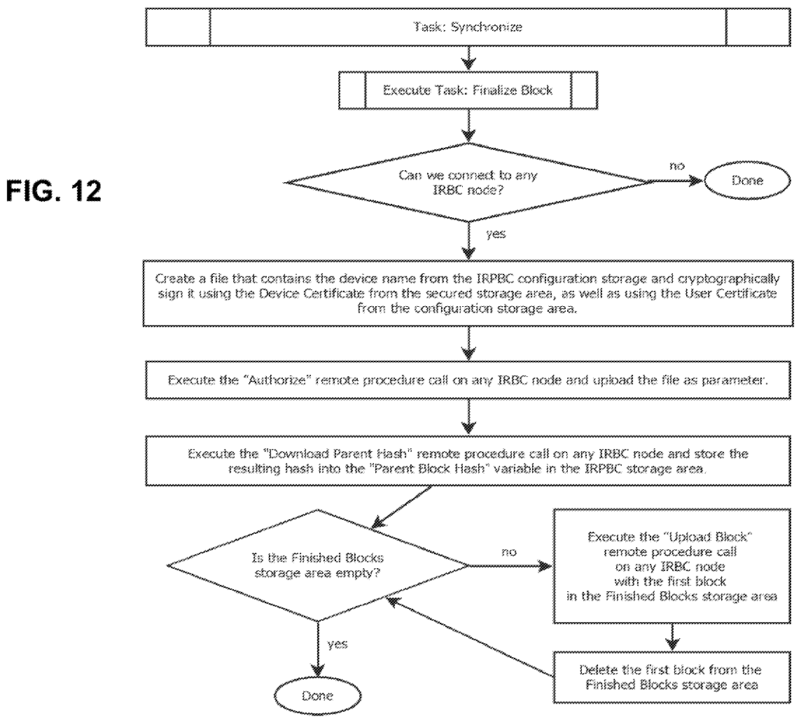

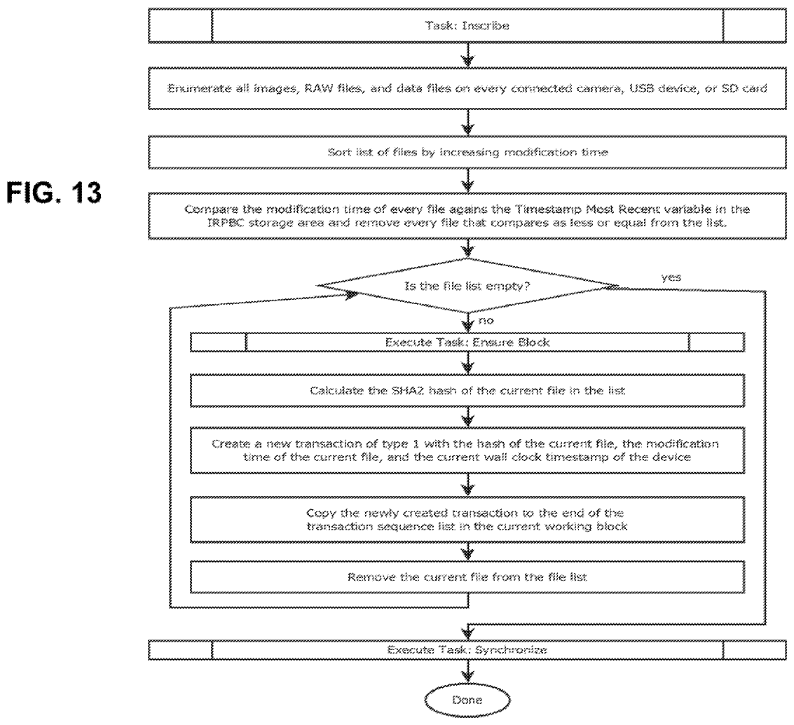

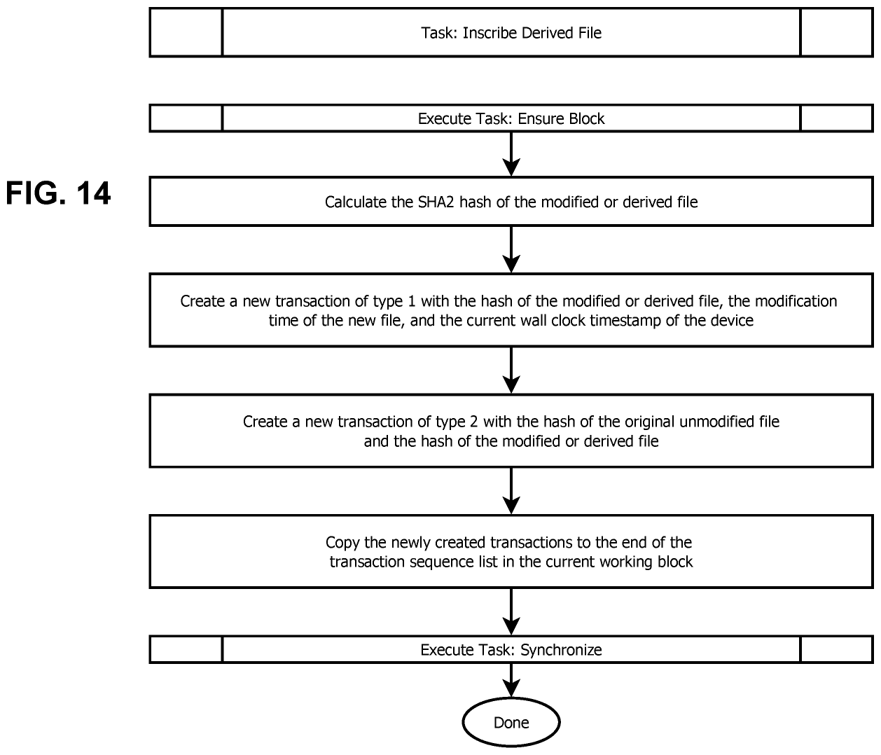

Turning to FIGS. 10-14, exemplary flow diagrams show the tasks of the IRPBC, according to some embodiments. In some embodiments, to restrict resource usage, the IRPBC may not perform multi-tasking but will instead work on specific tasks sequentially. The execution of tasks may be triggered by external events, for example, a change in Internet connectivity, the insertion/ejection of an SD card, or the arrival of new data, such as when a camera takes a new image. The execution of tasks may also be triggered by timers or by other tasks. For management, the IRPBC system may maintain a queue of which tasks are to be executed.

In other embodiments, for example, when resource usage restriction is not needed, the IRPBC may perform multi-tasking.

In some embodiments, the IRPBC task “Synchronize” may be scheduled if the device obtains Internet connectivity after being offline, by a timer to run every 30 seconds (or other set times), and if the user requests so, for example by pressing a synchronize button on the device.

In some embodiments, the IRPBC task “Inscribe” may be scheduled, e.g., on shutter release if integrated into a device with camera, upon insertion of an SD card, or when a USB device has been connected. The IRPBC task “Inscribe Derived File” may be scheduled when a file is modified or when the user converts a file to a new format, for example when a photographer exports a JPEG image based on a RAW file.

In some embodiments, the IRPBC tasks “Ensure Block” and “Finalize Block” may only be executed as part of other tasks and not scheduled separately.

### IRBC: Semi-Private Blockchain

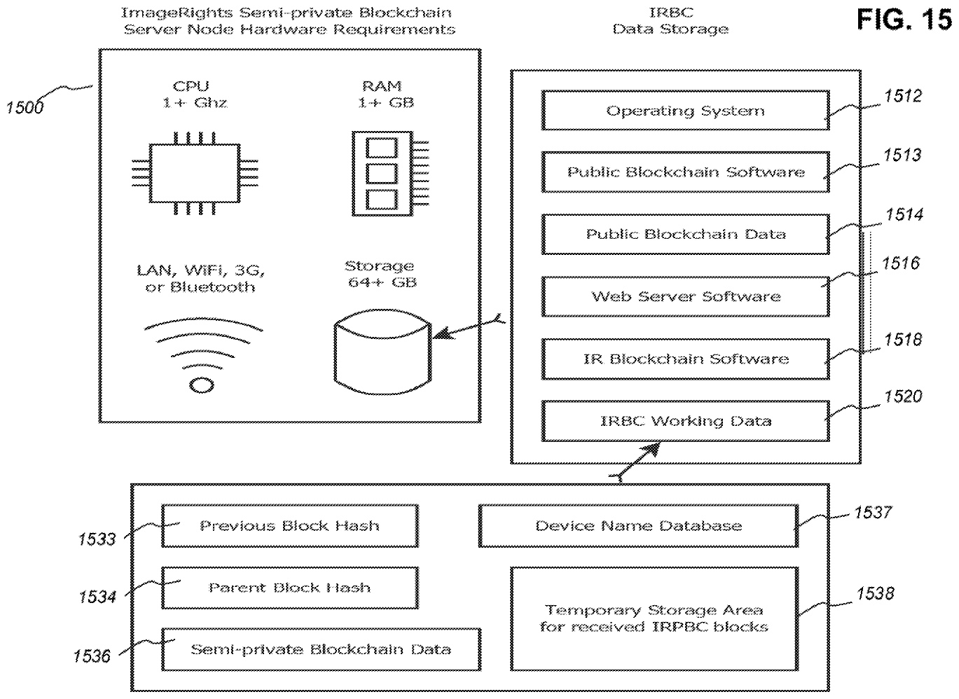

FIG. 15 illustrates exemplary components for an IRBC 1500, according to some embodiments. The IRBC may be or may include a software suite to be executed on servers, desktop workstations, laptops, tablets, mobile phones and more powerful embedded devices. In some implementations, the IRBC may require 1+GHz of processor speed, 1+GB of RAM and 64+GB of hard disk storage. In one aspect, an exemplary implementation may include Google Go and C++, so that the exact same source code can be used for deployment on ARM mobile phones as well as on x86_64 server hardware.

In some embodiments, an IRBC deployment may include at least the system's IR Blockchain software (or IRBC software) 1518, an operating system 1512 for basic input/output functions, and for controlling the network connectivity and a web server software 1516, such as Apache2, for RPC calls and for displaying status information to other participants and users.

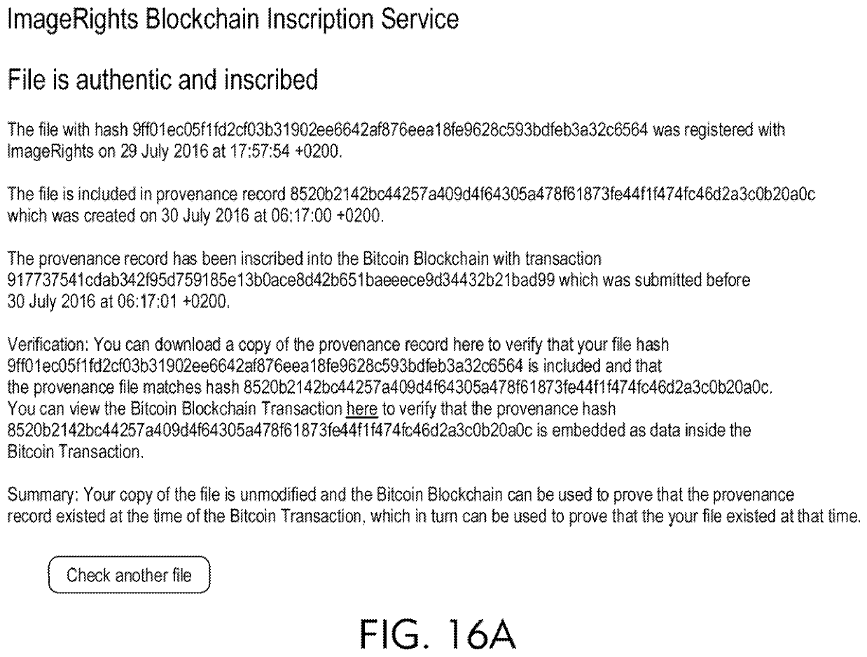

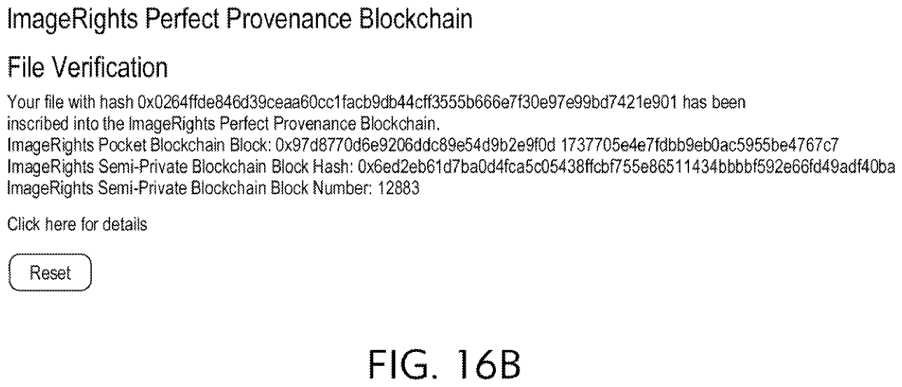

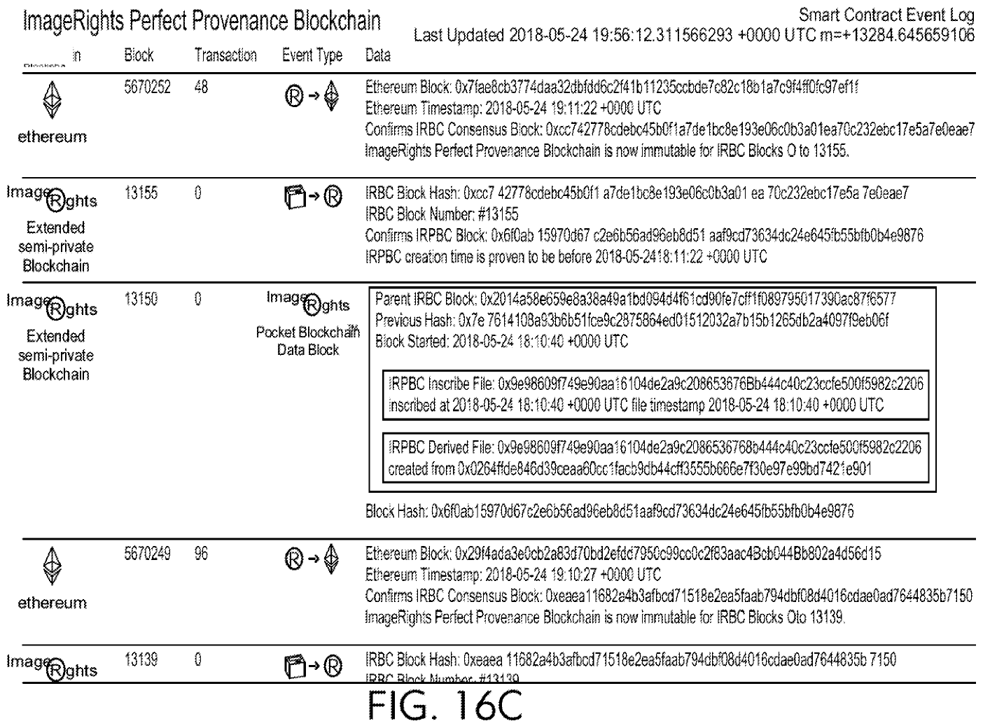

FIG. 16A illustrates an example of such status information, showing an image of a BitCoin Blockchain inscription verification website from an exemplary implementation of the system that users can use to verify that a given file has been inscribed and not been modified since.

FIG. 16B illustrates another exemplary user interface showing verification status of a file, showing confirmation that a file has been inscribed into the IRBC, along with the hash and block number information.

FIG. 16C illustrates another exemplary user interface showing a smart contract event log, which is the transaction log of the image files being hashed and inscribed first into the IRPBC, then the IRBC and ultimately the Ethereum public Blockchain.

In some embodiments, an IRBC (or IRBC node) may also store the client software and the data required for participating in a public Blockchain (see also blocks 1513 “Public Blockchain Software” and 1514 “Public Blockchain Data” in FIG. 15). In an exemplary implementation, Ethereum may be used, but a different client or the use of another network instead of Ethereum is also possible with minimal modifications. In some embodiments, all IRBC nodes may share one smart contract deployed on the public Blockchain, which is used for inscribing hashes from the semi-private Blockchain and distributing those inscription events to every IRBC node. If needed, the smart contract can also be replaced with data transactions submitted to the network on every event, but at an additional cost. Otherwise, the smart contract needs to be deployed to the network as part of the initial set-up of the system and the contract address is then stored in the IRBC node configuration.

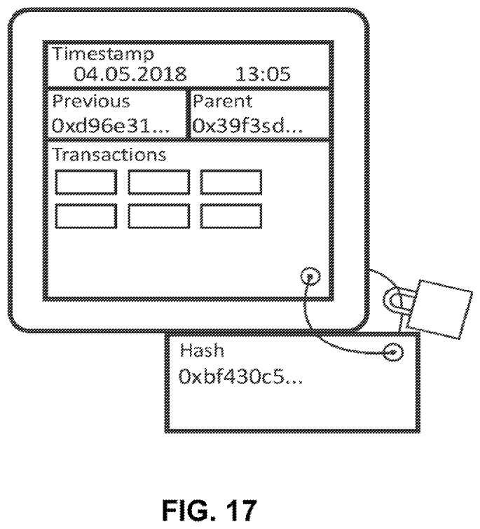

In some embodiments, inside an IRBC Working Data (see 1520 in FIG. 15), the hash of the most recent consensus block from the public Blockchain (see 1534 in FIG. 15) as well as the hash of the most recent consensus block from the semi-private Blockchain (see 1533 in FIG. 15) may be stored. The data storage for the semi-private Blockchain (see 1536 in FIG. 15) may be a Blockchain-like ledger contained of data blocks that have been extended to support hierarchical embedding in addition to regular Blockchain functionality through the addition of the “Parent” field, as shown in FIG. 17 (also as 502 and 510 in FIG. 5). In some embodiments, the data for the semi-private blockchain (see 1538 in FIG. 15) may be the data that was uploaded from the offline-capable hardware devices into the system's blockchain.

In some embodiments, data uploaded through RPC calls from the IRPBC devices 800 to the IRBC node 1500 and stored into the temporary storage area 1538 may be included into the next block added to the semi-private blockchain data 1536. In other words, the data that the pocket blockchain box 800 uploads to the server 1500 may be stored into temporary storage area 1538 and then later copied into a data block in the semi-private Blockchain 1536.

For each block that the IRBC node creates, the hash of the most recent consensus block from the public Blockchain (see 1514) may be included in the Parent field, thereby tying the blocks in the semi-private Blockchain to the blocks in the public Blockchain. And in the other direction, the hash of the most recent consensus block in the semi-private Blockchain may be regularly inscribed into the public Blockchain through the smart contract.

For public Blockchains, immutability is derived from the so-called “Proof of Work”, which is a competition of cryptographic puzzles that all Blockchain miners engage in, and which is extremely expensive due to electricity costs. For the extended semi-private Blockchain, long-time immutability may be warranted by the smart contract inscription, and short-term consensus is acquired cooperatively using, for example, the Paxos algorithm. That way, the extended semi-private Blockchain has exponentially reduced electricity use and is, thus advantageously, both deployable on mobile devices and affordable to operate.

Another part of the IRBC Working Data 1520 may be a database 1537 which may include the most recently seen device name for each public key hash of each device certificate. This may be used, for example, for displaying human-readable names on the status webpage(s) and can be removed if device naming is not needed.

The IR Blockchain software running on each IRBC node may provide several services, some as recurring tasks, some as remote procedure calls (RPC) that can be accessed by IRPBC devices through the web server, and some as event handlers to be executed in response to an outside event, such as smart contract notifications received through the public Blockchain.

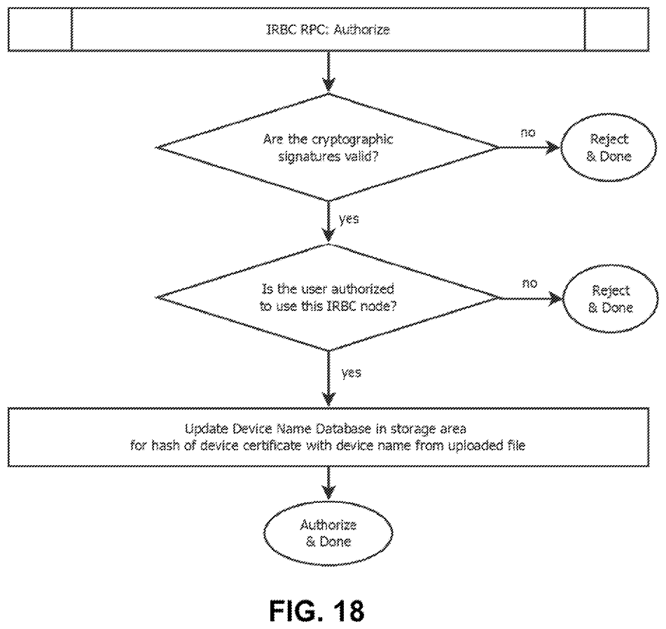

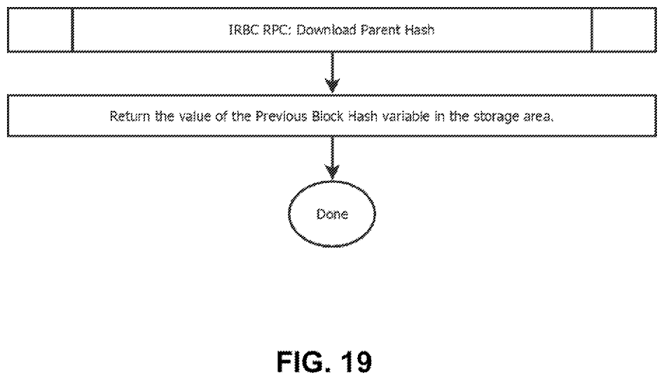

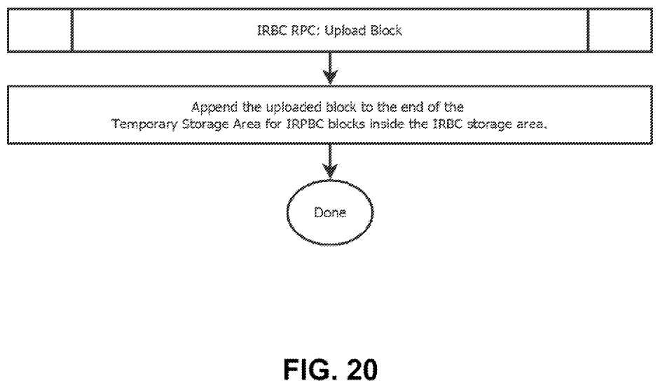

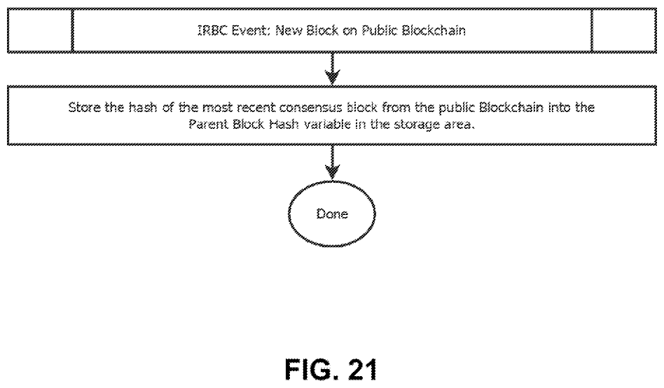

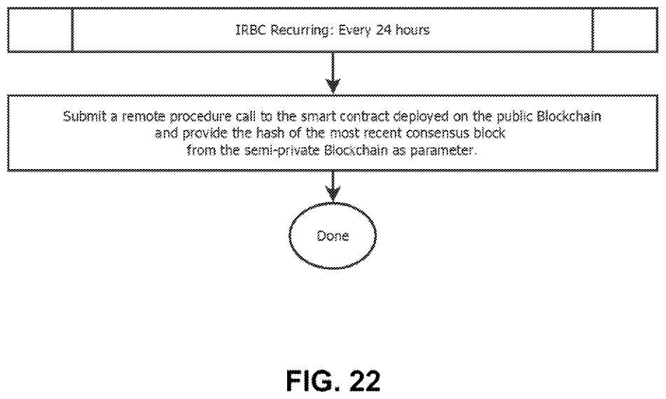

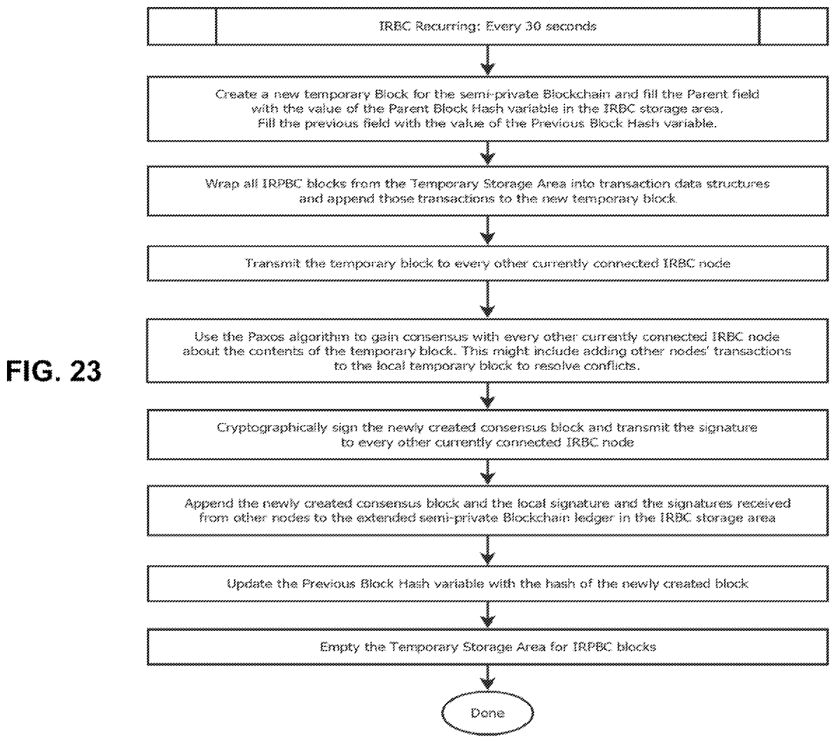

FIGS. 18 to 23 illustrate exemplary flow diagrams of exemplary tasks of the IRBC, according to some embodiments.

### IRBC Node Notary or Government Registration—An Exemplary Use Case

In addition to its duties in supporting the IRPBC devices and maintaining the semi-private Blockchain and its integration with the public Blockchain, the IRBC nodes can also upgrade the level of trustworthiness of the information inscribed into the Blockchain (and Blockchain-like) hierarchy by creating additional provenance for the correctness of the confirmed information.

As described above, new data and/or new files can be inserted into the Pocket Blockchain nearly immediately by IRPBC devices. That data can then be confirmed and inscribed into the semi-private Blockchain. That data can then be confirmed and inscribed into the public Blockchain. If files are modified, or if derived files are created, they can be inscribed in a similar way into Pocket Blockchain, semi-private Blockchain and public Blockchain. Due to the design of the Blockchain hierarchy, this process provides provenance for the existence and authenticity of the inscribed files at various time scales, where each subsequently larger and more trustworthy time range includes and confirms the included smaller time ranges. As a final step, the chain of inscriptions can be confirmed by a government agency or a notary service to generate provenance at the highest possible level of trustworthiness.

This concept may be best understood with a practical example from an exemplary implementation. In some exemplary operations, if a photographer is using a camera with integrated IRPBC hardware component, then every new photo is inscribed as the RAW file immediately. If the same photographer also uses processing software with integrated IRPBC software component, then upon the creation of the retouched finished JPEG images, they are immediately inscribed as derivative works created from the RAW files. All of these inscriptions are cryptographically signed with the user's certificate, which use the system to prove the shared origin without disclosing the author's identity. As a result, the system can automatically collect all required information for all RAW files and the derived JPEG files to register the newly created works with the U. S. Copyright Office. The resulting USCO Certificate can then be inscribed into the Blockchain again, to be linked with the JPEG images and RAW files.

The system described herein is suitable for managing and tracking data and files of any kind, but there can be multiple government offices and notary services, one for each type of data. Accordingly, while the overall system is data-agnostic, the component for government registration may need to be specifically designed or adapted for each type of data.

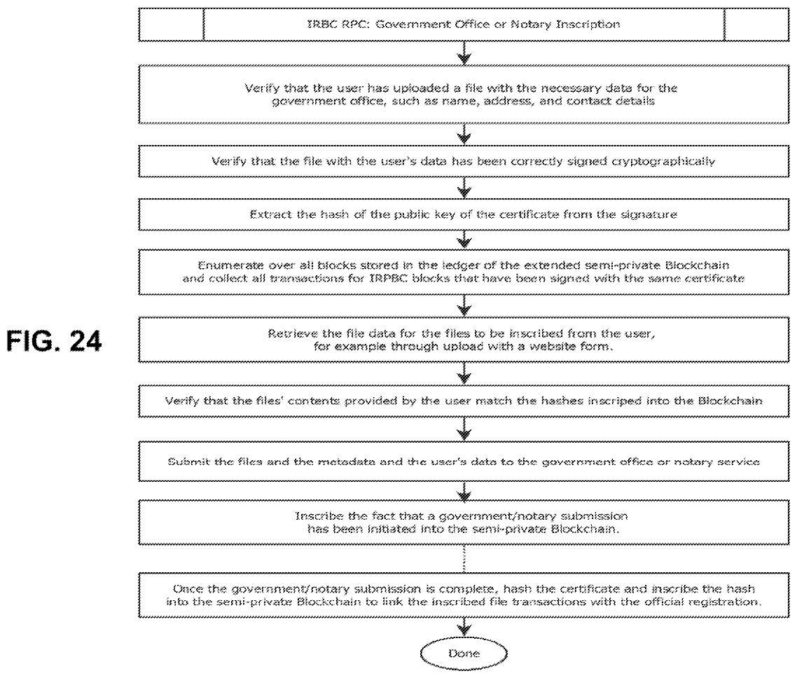

FIG. 24 shows an exemplary flow diagram of the steps for the creating and submitting copyright work records. In some embodiments, the IRBC may aggregate the data required for U.S. Copyright Office (USCO) registration, automatically submit that registration data to the USCO copyright office. Then once the USCO issues the registration certificate, it would be scanned into the system, which would generate a new hash inscribed into the IRBC for the certificate that would be linked to image history already contained in the IRBC.

### Automation and Organization

In some embodiments, if the IRBC nodes are implemented as suggested with the device name database, then the data from the extended semi-private Blockchain can also be used for automatically identifying a known file based on its hash and to automatically identify both the user that has created the file and the device that was used for creation.

In the example of a team of traveling photographers, the IRBC nodes implemented with the Device Name Database may be used to automatically sort the resulting images into folders based on author and camera, even in the complete absence of file metadata.

In the example of an IoT GPS tracker embedded into a car, the company owning the car could use the blockchain data to distribute work trips evenly to the available cars, as to minimize the average degree of wear and tear.

In another example, if every employee in a hospital has a unique personal RFID-capable name tag, then the logging data from the IRPBC hardware integrated into hospital equipment could be used for compliance documentation, such as automatically logging which drug has been given at which time using which tools and by which nurse or doctor.

### Image License and Contract Management

In some embodiments, the system described above can manage, inscribe and warrant arbitrary types of data, files or timestamped events. The system may provide services to photographers and agencies who are producing new content and want to protect it with government registrations, such as with an USCO registration service. The system may also provide license verification and policing services, such as a service to detect unauthorized uses and a recovery service to recover lost licensing revenue. For the latter two services, it may be important that the system has accurate information about which customer is allowed to use what image content, and about the usual sales price for a given image license.

Examples shown above include use-cases describing a photographer using the system Blockchain to prove rights with regards to RAW files and JPEG images up until registration with the U. S. Copyright Office. However, because the system can handle arbitrary files and also file changes, it can additionally, alternative, or simultaneously be used for managing image licensing information in a machine-readable format. Even more generally, the system can be used for managing and updating contracts of any kind. As another example, an insurance salesperson could install an app that includes both the contract specification logic and an integrated IRPBC software module so that provenance for the proposed contracts can be inscribed directly on the mobile device. Blockchain technology, as it is known and practiced in the art today, requires the payment of high transaction fees and requires permanent internet connectivity to function correctly. As such, the adoption by traveling employees has been severely limited. The low resource requirements of the Pocket Blockchain together with its offline capabilities and the affordable operating costs of IRBC nodes could help to enable the use of Blockchain-like technology in new situations.

In some embodiments, sophisticated dashboards and user interfaces can be provided.

Additionally, the present disclosure also includes systems and methods for validating the data acquired before use.

The embodiments of the present disclosure provide for improvements over prior modes in the field of data creation and tracking using consensus-driven semi-private blockchain. These improvements can include, for example, optimization of computer resources, improved data accuracy and improved data integrity, to name only a few. In a number of embodiments, instructions stored in the memory of computing devices (e.g., software) can cause one or more processors of the system perform the steps of the embodiments here.

The improvements of the present disclosure are necessarily rooted in computer-based systems for the tracking creation and modification of digital records using consensus-driven semi-private blockchain. Additionally, many of the embodiments disclosed herein reflect an inventive concept in the particular arrangement and combination of the devices, components and method steps utilized for the tracking creation and modification of digital records using consensus-driven semi-private blockchain.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

These embodiments and others described herein are improvements in the fields of computer-assisted events ticketing. Other systems, devices, methods, features and advantages of the subject matter described herein will be apparent to one with skill in the art upon examination of the attached Appendices. The various configurations of these devices are described by way of the embodiments which are only examples.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

1. A system for tracking creation and modification of digital records using consensus-driven semi-private blockchain, comprising:
a first plurality of nodes comprising a public blockchain;
a second plurality of intermediate nodes comprising a semi-private blockchain and communicating with the first plurality of nodes, wherein one or more nodes of the intermediate nodes host a server software;
a plurality of user devices, wherein each user device comprises a blockchain client and communicates with one or more nodes of the intermediate nodes to ingest first data into the one or more nodes of the intermediate of nodes; and
one or more third-party authorities communicating with the one or more nodes of the intermediate nodes.

2. The system of claim 1, wherein the blockchain client inscribes the first data, forming first inscribed data, before ingesting the first inscribed data into the one or more nodes of the intermediate nodes.

3. The system of claim 2, wherein the blockchain client is offline.

4. The system of claim 1, wherein the intermediate nodes inscribe the first inscribed data ingested from the plurality of user devices, forming second inscribed data, and ingest the second inscribed data into the one or more first plurality of nodes.

5. The system of claim 4, wherein the intermediate nodes register the second inscribed data with one or more third-party authorities.

6. The system of claim 5, wherein the intermediate nodes register the second inscribed data with one or more third-party authorities after a predetermined time.

7. The system of claim 4, wherein the intermediate nodes ingest the second inscribed data into the one or more first plurality of nodes after a predetermined time.

8. The system of claim 1, wherein the each user device comprises a cryptographic device certificate.

9. The system of claim 1, wherein the each user device is randomly connected to one intermediate node.

10. The system of claim 1, wherein the first data comprises blockchain-like data structure, the data structure comprises at least one of a timestamp, a hash of a previous first data block, a hash of a parent public blockchain data block, and one or more transactions.

11. The system of claim 10, wherein the first data further comprises a cryptographic user certificate.

12. The system of claim 11, wherein a block hash is created based on the hash of a previous first data block, the hash of a parent public blockchain data block, the one or more transactions, the cryptographic user certificate, and a cryptographic device certificate.

13. The system of claim 10, wherein the parent public blockchain data block is a most recent consensus public blockchain data block.

14. The system of claim 1, wherein the intermediate node is a hosted server.

15. The system of claim 1, wherein the blockchain client comprises a software library.

16. The system of claim 1, wherein the blockchain client comprises a dedicated hardware.

17. The system of claim 1, wherein the each user device is an integrated circuit integrated in a digital camera.

18. The system of claim 1, wherein the each user device is an SD card in a digital camera.

19. The system of claim 1, wherein the one or more third-party authorities is the U.S. Copyright Office.

20. The system of claim 1, wherein the one or more third-party authorities is a notary office.
